(19) United States
(12) Patent Application Publication
(10) Pub. No.: US 2014/0193187 A1
(43) Pub. Date: Jul. 10, 2014

(54) RECORDING APPARATUS AND RECORDING METHOD

(71) Applicant: SEIKO EPSON CORPORATION, Tokyo (JP)

(72) Inventor: Hirotaka ISHIZUKA, Shiojiri (JP)

(73) Assignee: SEIKO EPSON CORPORATION, Tokyo (JP)

(21) Appl. No.: 14/150,964

(22) Filed: Jan. 9, 2014

(30) Foreign Application Priority Data
Jan. 10, 2013 (JP) 2013-002541
Nov. 26, 2013 (JP) 2013-243746

(51) Int. Cl. B41J 13/00

(52) U.S. Cl. CPC B41J 13/00
USPC 400/618

(57) ABSTRACT

A recording apparatus includes a conveyance mechanism, a sticking section and an adjustment section. The conveyance mechanism has an adhesive belt on which a recording medium is placed, and configured and arranged to intermittently convey the recording medium. The sticking section is configured and arranged to apply pressure to the recording medium to stick the recording medium to the adhesive belt. The adjustment section is configured and arranged to adjust a pressure force applied by the sticking section to the recording medium. The adjustment section is configured and arranged to change the pressure force so that the pressure force during conveyance of the recording medium is greater than the pressure force during stopping of the recording medium.

### CROSS-REFERENCE TO RELATED APPLICATIONS

This application claims priority to Japanese Patent Application No. 2013-002541 filed on Jan. 10, 2013 and Japanese Patent Application No. 2013-243746 filed on Nov. 26, 2013. The entire disclosure of Japanese Patent Application Nos. 2013-002541 and 2013-243746 is hereby incorporated herein by reference.

### BACKGROUND

1. Technical Field

The present invention relates to a recording apparatus provided with a conveyance mechanism for conveying a recording medium placed on movable belt, and to a recording method.

2. Background Technology

Recording apparatuses provided with a conveyance mechanism for conveying a recording medium placed on a movable belt have been conventionally used. Disclosures of such recording apparatuses include a recording apparatus provided with an adhesive belt coated with an adhesive by which the recording medium is releasably adhered to and retained on a surface for placement of the recording medium, as the movable belt. For example, patent document 1 discloses a recording apparatus provided with an endless belt for adhesively fixing and conveying a recording medium, and a cleaning section equipped with a wiping roller of which the peripheral surface is composed of a porous polymer body.

In a recording apparatus provided with such an adhesive belt, it is common for there to be provided a sticking section, such as a pressure roller, for sticking the recording medium to the adhesive belt without causing wrinkling, floating up, and the like.

Japanese Laid-open Patent Publication No. 11-192694 (Patent Document 1) is an example of the related art.

### SUMMARY

In a recording apparatus for recording by reciprocatingly scanning a recording belt in a direction intersecting with a direction of conveyance of a recording medium and ejecting ink, the conveyance of the recording medium is an intermittent conveyance because of the need for the recording medium to be conveyed so as to correspond to the reciprocating scanning of the recording belt. In a recording apparatus of such a configuration wherein a sticking section such as a pressure roller is provided, however, the intermittent conveyance of the recording medium is associated with the occurrence, in the recording medium, of a portion to which pressure is applied for a longer time by the sticking section (a portion to which pressure is applied from the sticking section in a stopped state) and a portion to which pressure is applied for a shorter time by the sticking section (a portion to which pressure is applied from the sticking section only in a moving state). For this reason, in some instances the recording medium is thinner at the portion to which pressure is applied for a longer time by the sticking section than at the portion to which pressure is applied for a shorter time by the sticking section, creating an unevenness in the thickness of the recording medium on the adhesive belt. The uneven thickness of the recording medium, then, in some instances causes an uneven color in the recorded image that is formed on the recording medium. Such uneven color of the recorded image is especially noticeable on the side opposite to a recording surface of a fabric in a case where a fabric is used as the recording medium, but in some instances the uneven color is clearly recognizable on the recording surface, too. The recording apparatus of patent document 1 makes no mention relating to suppressing the color unevenness of the recorded image by suppressing the thickness unevenness in the recording medium.

Therefore, an objective of the present invention is to suppress a color unevenness in a recorded image by suppressing a thickness unevenness in a recording medium that is created by applying pressure to the recording medium to stick the recording medium to an adhesive belt.

A recording apparatus of a first aspect of the present invention includes a conveyance mechanism, a sticking section and an adjustment section. The conveyance mechanism has an adhesive belt on which a recording medium is placed, and configured and arranged to intermittently convey the recording medium. The sticking section is configured and arranged to apply pressure to the recording medium to stick the recording medium to the adhesive belt. The adjustment section is configured and arranged to adjust a pressure force applied by the sticking section to the recording medium. The adjustment section is configured and arranged to change the pressure force so that the pressure force during conveyance of the recording medium is greater than the pressure force during stopping of the recording medium.

In the recording apparatus, which records by reciprocatingly scanning a recording head in a direction of scanning that intersects with a direction of conveyance of the recording medium, the conveyance mechanism stops the conveyance of the recording medium during the recording and scanning (during movement of the recording head). Expressed differently, recording involves alternating between reciprocating scanning of the recording head and conveyance of the recording medium. For this reason, in a recording apparatus where the pressure applied to the recording medium by the sticking section is constant, the pressure time during stopping of the recording medium associated with the intermittent conveyance is longer than the pressure time during movement of the recording medium associated with the intermittent conveyance, and this causes an unevenness to be more likely to occur in the thickness of the recording medium. According to this aspect, the adjustment section changes the pressure force so that the pressure force during conveyance of the recording medium is greater than the pressure force during stopping of the recording medium. For this reason, the occurrence of an uneven thickness in the recording medium can be suppressed, and an uneven color in the recorded image can be suppressed.

A recording apparatus of a second aspect of the present invention is the first aspect, wherein the adjustment section preferably includes a rotating section configured and arranged to rotate in tandem with the recording medium being conveyed.

According to this aspect, the rotating section for rotating in tandem with the recording medium being conveyed makes it possible to change the pressure force so that the pressure force during conveyance of the recording medium is greater than the pressure force during stopping of the recording medium.

A recording apparatus of a third aspect of the present invention is the second aspect, wherein the adjustment section is preferably configured and arranged to control the pressure force of the sticking section so as to reduce a difference between: a product of the pressure force and pressure time applied per unit surface area during the stopping of the recording medium associated with the intermittent conveyance; and a product of the pressure force and pressure time applied per unit surface area during the conveyance of the recording medium associated with the intermittent conveyance.

According to this aspect, the difference between: the product of the pressure force and pressure time applied per unit surface area during the stopping of the recording medium associated with the intermittent conveyance; and the product of the pressure force and pressure time applied per unit surface area during the movement of the recording medium associated with the intermittent conveyance is reduced. For this reason, the occurrence of an uneven thickness in the recording medium can be suppressed, and an uneven color in the recorded image can be suppressed. Most preferably, there is substantially no difference between: the product of the pressure force and pressure time applied per unit surface area during the stopping of the recording medium associated with the intermittent conveyance; and the product of the pressure force and pressure time applied per unit surface area during the movement of the recording medium associated with the intermittent conveyance.

A recording apparatus of a fourth aspect of the present invention is any of the first through third aspects, wherein a portion of the sticking section configured and arranged to contact the recording medium preferably has a length in a direction of scanning that is equal to or greater than a length of the recording medium in the direction of scanning.

According to this aspect, pressure can be applied to the entire recording medium in the direction of scanning intersecting with the direction of conveyance. That is to say, pressure can be applied to the recording medium with a broad contact surface, and for this reason, the occurrence of an uneven thickness in the recording medium can be suppressed, and an uneven color in the recorded image can be suppressed.

A recording apparatus of a fifth aspect of the present invention is any of the first through fourth aspects, preferably further including a movement mechanism for the sticking section configured and arranged to move the sticking section so as to draw closer to or farther away from the adhesive belt.

According to this aspect, placing the recording medium on the adhesive belt could involve momentarily separating the sticking section from the adhesive belt, placing a leading end of the recording medium on the adhesive belt, and then bringing the sticking section close to the adhesive belt and applying pressure to the recording medium. For this reason, there is improved operability for when the recording medium is placed onto the adhesive belt.

A recording method according to a sixth aspect is a method performed by using a recording apparatus including: a conveyance mechanism having an adhesive belt on which a recording medium is placed, and configured and arranged to intermittently convey the recording medium; and a sticking section configured and arranged to apply pressure to the recording medium to stick the recording medium to the adhesive belt. The recording method includes adjusting a pressure force applied by the sticking section to the recording medium so that the pressure force applied during conveyance of the recording medium is greater than the pressure force applied during stopping of the recording medium.

According to this aspect, the pressure force applied by the sticking section during conveyance of the recording medium is greater than the pressure force applied during stopping of the recording medium. For this reason, the occurrence of an uneven thickness in the recording medium can be suppressed, and an uneven color in the recorded image can be suppressed.

### BRIEF DESCRIPTION OF THE DRAWINGS

Referring now to the attached drawings which form a part of this original disclosure:

FIG. 1 is a schematic side view representing a recording apparatus as in an embodiment 1 of the present invention;

FIG. 2 is a schematic plan view representing the recording apparatus as in the embodiment 1 of the present invention;

FIG. 3 is a block diagram of the recording apparatus as in the embodiment 1 of the present invention;

FIGS. 4A-4C are drawings for describing a method of control for a control unit of the recording apparatus as in the embodiment 1 of the present invention;

FIG. 5 is a schematic side view representing a recording apparatus as in an embodiment 2 of the present invention;

FIG. 6 is a schematic side view representing a recording apparatus as in an embodiment 3 of the present invention; and

FIG. 7 is a flow chart representing an embodiment of a recording method of the present invention.

### DETAILED DESCRIPTION OF EXEMPLARY EMBODIMENTS

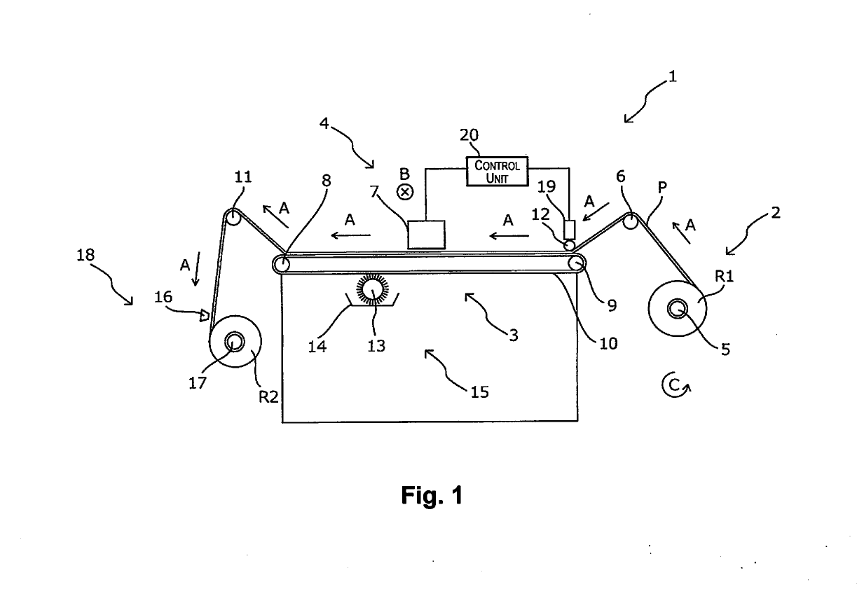

### Embodiment 1 (FIGS. 1 to 4A-4C)

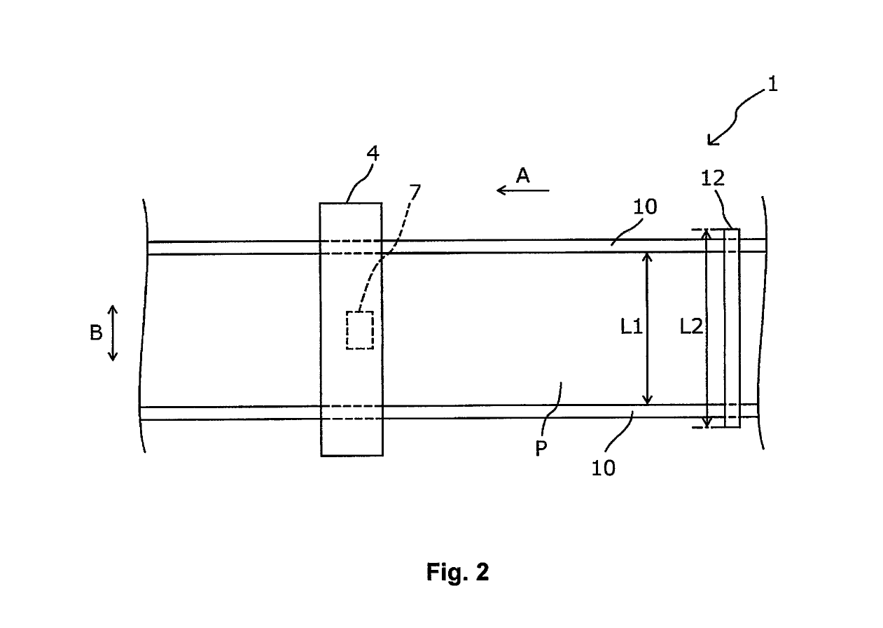

Recording apparatuses as in embodiments of the present invention shall be described in greater detail below, with reference to the accompanying drawings. First, a recording apparatus as in an embodiment 1 of the present invention shall be described. FIG. 1 is a schematic side view of a recording apparatus 1 as in the embodiment 1 of the present invention, and FIG. 2 is a schematic plan view of the recording apparatus 1 as in the embodiment 1 of the present invention.

The recording apparatus 1 of the present embodiment is provided with a set section 2 by which a roll R1 of a recording medium P for carrying out recording can be fed out. The recording apparatus 1 is also provided with: a pressure roller 12, serving as a sticking section for pressing the recording medium P against an adhesive belt 10 serving as a movable belt and sticking the recording medium P to the adhesive belt 10; and a conveyance mechanism 3 for conveyance of the recording medium P in a direction of conveyance A by the adhesive belt 10. The recording apparatus is further provided with a recording mechanism 4 for recording by reciprocatingly scanning a recording head 7 in a direction of scanning B that intersects with the direction of conveyance A of the recording medium P. The recording apparatus 1 is moreover provided with a cleaning mechanism 15 for cleaning the adhesive belt 10. The recording apparatus 1 is additionally provided with a take-up mechanism 18 including a take-up spindle 17 for taking up the recording medium P and a cutter 16 for cutting the recording medium P being taken up.

The sect section 2 is provided with a rotating shaft 5 doubling as a setting position of the roll R1 of the recording medium P for carrying out recording, and is configured so that the recording medium P can be fed out to the conveyance mechanism 3 via a driven roller 6 from the roll R1 that has been set onto the rotating shaft 5. When the recording medium P is being fed out to the conveyance mechanism 3, the rotating shaft 5 rotates in a direction of rotation C.

The conveyance mechanism 3 is provided with: the adhesive belt 10, which drives the recording medium P fed out from the set section 2, the recording medium P having been placed onto the adhesive belt 10; and a conveyance roller 8 and driven roller 9, for moving the adhesive belt 10. Pressed against the adhesive belt 10 by the pressure roller 12, the recording medium P is thereby stuck to and placed on the adhesive belt 10. When the recording medium P is being conveyed, the conveyance roller 8 rotates in the direction of rotation C.

The pressure roller 12 is pressed onto the recording medium P by a pressure roller drive section 19, which is a drive section for driving the pressure roller 12, and the pressing force thereof is controlled (adjusted) by a control unit 20 serving as an adjustment section. The control unit 20 is connected to the pressure roller drive section 19, the recording mechanism 4, the conveyance mechanism 3, and the like, and carries out a control for intermittently conveying the recording medium so as to correspond to the reciprocal scanning of the recording head 7. Then, along with this control, the pressure roller drive section 19 is controlled so that the pressure roller 12 applies pressure to the recording medium P such that the pressing force during movement of the recording medium P associated with the intermittent conveyance is greater than the pressing force during stopping of the recording medium P associated with the intermittent conveyance. Expressed differently, the control unit 20 controls the pressing force so that the pressing force of the pressure roller 12 during conveyance of the recording medium P is greater than the pressing force during stopping of the recording medium P. The pressure roller drive section 19 is not limited, provided that the configuration allow for the recording medium P to be pressed by the pressure roller 12. Examples of configurations that could be adopted include one in which there are a solenoid valve, pressure gauge, and the like, and the pressure roller 12 is made to press against the recording medium P at a predetermined pressure by aerodynamics.

The configuration is also such that a movement mechanism of the sticking section (not shown) makes it possible to move the pressure roller 12 closer to and away from the adhesive belt 10. For this reason, placing the recording medium P on the adhesive belt 10 could involve momentarily separating the pressure roller 12 from the adhesive belt 10, placing a leading end of the recording medium P on the adhesive belt 10, and then bringing the pressure roller 12 close to the adhesive belt 10 and applying pressure to the recording medium P. That is to say, there is favorable operability in placing the recording medium P on the adhesive belt 10.

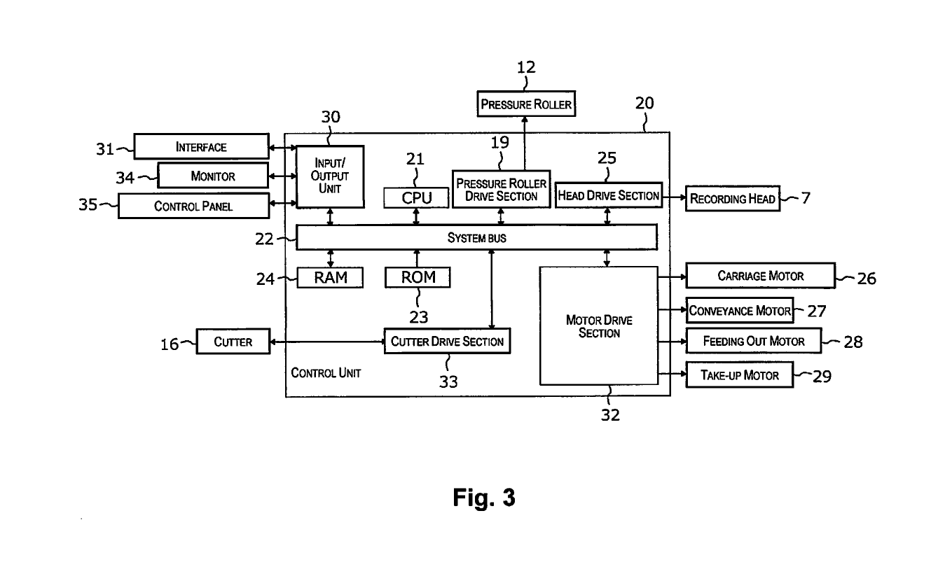

The recording mechanism 4 has the recording head 7, a carriage (not shown) loaded with the recording head 7, and a carriage motor 26 (see FIG. 3) for reciprocatingly moving the carriage in the direction of scanning B. In FIG. 1, the direction of scanning B is the direction perpendicular to the plane of the paper. Recording involves recording by reciprocatingly scanning the recording head 7, where the conveyance mechanism 3 stops the conveyance of the recording medium P during the recording and scanning (during movement of the recording head). Expressed differently, recording involves alternating between reciprocating scanning of the recording head 7 and conveyance of the recording medium P. That is to say, during recording, the conveyance mechanism 3 intermittently conveys the recording medium P so as to correspond with the reciprocating scanning of the recording head 7. [0027] The cleaning mechanism 15 for cleaning the adhesive belt 10 includes a cleaning unit 13 configured by coupling a plurality of cleaning rollers together in a rotating shaft direction, and a tray 14 in which is placed a cleaning agent serving as a cleaning mechanism of the cleaning unit 13.

The take-up mechanism 18 is a mechanism for taking up the recording medium P onto which recording has been done and which has been conveyed from the conveyance mechanism 3 via the driven roller 11; by being wound around a paper tube for take-up or the like that has been set onto the take-up spindle 17, the recording medium P can be taken up as a roll R2 of the recording medium P.

As represented in FIG. 2, in the recording apparatus 1 of the present embodiment, the pressure roller 12 has a length L2 in the direction of scanning B at a site of contact with the recording medium P, which length L2 is equal to or greater than a length L1 in the direction of scanning B on the recording medium P. For this reason, pressure is applied to the entire recording medium P in the direction of scanning B. That is to say, the pressure roller 12 can apply pressure to the recording medium P with a large contact surface, and thus the configuration allows for the suppression of an uneven thickness of the recording medium P and enables suppression of an uneven coloring of the recorded image.

The electrical configuration in the recording apparatus 1 of the present embodiment shall be described next. FIG. 3 is a block diagram of the recording apparatus 1 of the present embodiment. A CPU 21 that governs the control of the entirety of the recording apparatus 1 is provided to a control unit 20. The CPU 21 is connected over a system bus 22 to a ROM 23 that stores a variety of control programs executed by the CPU 21 and the like, and to a RAM 24 in which data can be temporarily stored. The CPU 21 is also connected over the system bus 22 to a head drive section 25 for driving the recording head 7.

The CPU 21 is further connected over the system bus 22 to a motor drive section 32 for causing driving by the carriage motor 26, by a conveyance motor 27, a by feeding-out motor 28, and by a turret motor 29. Here, the carriage motor 26 is a motor for moving the carriage onto which the recording head 7 has been loaded. The conveyance motor 27 is a motor for driving the conveyance roller 8. The feeding-out motor 28 is a rotational mechanism of the rotating shaft 5, and is a motor for driving the rotating shaft 5 in order to feed the recording medium P out to the conveyance mechanism 3. The take-up motor 29 is a drive motor for causing the take-up spindle 17 to rotate.

The CPU 21 is also connected over the system bus 22 to a cutter drive section 33 for driving the cutter 16 so as to cut the recording medium P. Further, the CPU 21 is connected to: a monitor 34 and control panel 35 provided to the recording apparatus 1; an interface 31 for, inter alia, inputting recording data or the like from an external device such as a PC; and an input/output unit 30 for transmitting and receiving data and signals.

The CPU 21 is also connected over the system bus 22 to the pressure roller drive section 19. The control unit 20 is in this manner connected over the system bus 22 or the like to the pressure roller drive section 19, the conveyance mechanism 3 (the conveyance motor 27), and the recording mechanism 4 (the recording head 7 and the carriage motor 26). Also, the control unit 20 controls the pressure force of the pressure roller 12 so as to reduce the difference between: the product of the pressure force and pressure time applied per unit surface area during the stopping of the recording medium P associated with the intermittent conveyance; and the product of the pressure force and pressure time applied per unit surface area during the movement of the recording medium P associated with the intermittent conveyance.

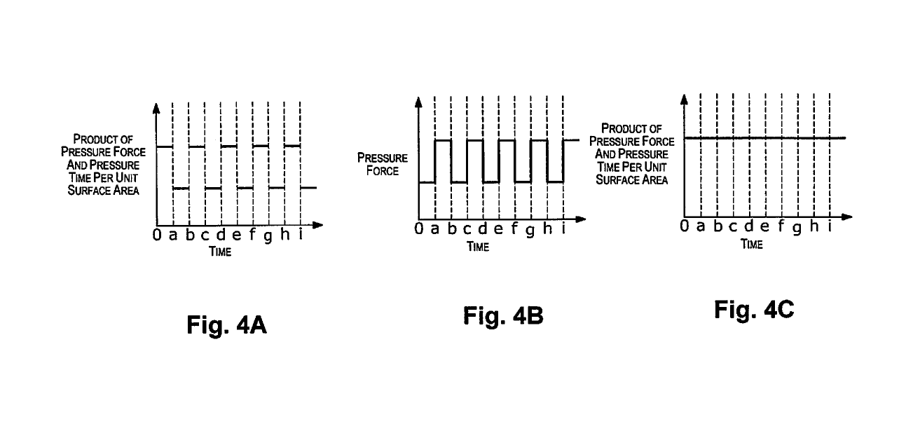

The method of control of the control unit 20 of the recording apparatus 1 of the present embodiment shall be described next. FIGS. 4A-4C are drawings for explaining the method of control of the control unit 20 of the recording apparatus 1 of the present embodiment. FIG. 4A is a graph representing the product of the pressure force and pressure time applied per unit surface area of the recording medium P in a case where the control unit 20 does not control the pressure force of the pressure roller 12 (a case where the pressure roller 12 continues applying a constant pressure force to the recording medium P). In the graphs of FIGS. 4A to 4C, the horizontal axis is time, where 0 to a, b to c, d to e, f to g, and h to i represent times of stopping of the recording medium P associated with the intermittent conveyance, and a to b, c to d, e to f, and g to h represent times of movement of the recording medium P associated with the intermittent conveyance. As is clear from FIG. 4A, in a case where the control unit 20 does not control the pressure force of the pressure roller 12, the product of pressure force and pressure time applied per unit surface area during stopping of the recording medium P is clearly greater than the product of the pressure force and pressure time applied per unit surface area during movement of the recording medium P.

FIG. 4B is a graph representing the pressure force applied by the pressure roller 12 to the recording medium P when the control unit 20 is controlling the pressure force of the pressure roller 12. As represented in FIG. 4B, the control unit 20 controls the pressure roller drive section 19 so that the pressure roller 12 applies pressure to the recording medium P such that the pressure force during movement of the recording medium P associated with the intermittent conveyance is greater than the pressure force during stopping of the recording medium P associated with the intermittent conveyance. In the recording apparatus 1 of the present embodiment, more specifically, the pressure force during movement of the recording medium P associated with the intermittent conveyance is intensified.

FIG. 4C is a graph representing the product of the pressure force and pressure time applied per unit surface area of the recording medium P in a case where the control unit 20 controls the pressure roller drive section 19 as represented in FIG. 4B. As represented in FIG. 4C, the product of the pressure force and pressure time applied per unit surface area during stopping of the recording medium P is substantially no longer different from the product of the pressure force and pressure time applied per unit surface area during movement of the recording medium P. The control need only be such that the difference between the two is reduced, though the most preferable is a configuration where, as per the present embodiment, the control is so as to substantially eliminate the difference between the products of the pressure force and pressure time applied per unit surface area of the recording medium P during stopping of the recording medium P and during movement thereof.

For there to no longer be a substantial difference between the products of the pressure force and pressure time applied per unit surface area of the recording medium P during stopping of the recording medium P and during movement thereof means, for example, the following. In a case where the stop time during stopping of the recording medium P is one second in a state where a pressure force of 1 kgf is applied, then the product is 1 kgf·s. The product would also be 1 kg·s in a case in which the time where the recording medium P per unit surface area (for example, 1 mm×1 mm) passes through the pressure roller 12 during movement of the recording medium P in a state where a pressure force of 10 kgf is applied is 0.1 second.

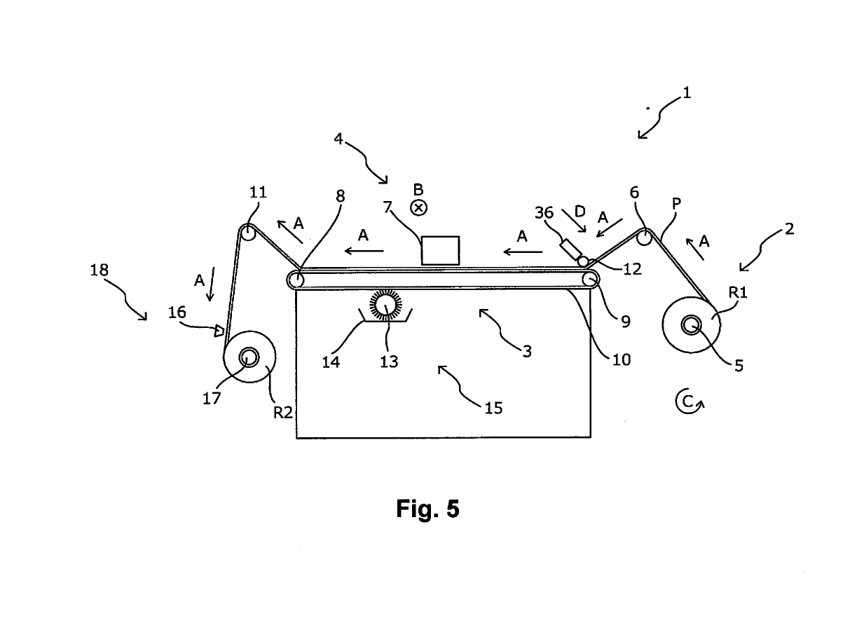

### Embodiment 2 (FIG. 5)

A recording apparatus as in an embodiment 2 of the present invention shall be described next. FIG. 5 is a schematic side view representing the recording apparatus as in the embodiment 2 of the present invention. Constituent members that are in common with the embodiment described above have been assigned like reference numerals, and a detailed description thereof is omitted herein.

The recording apparatus 1 of the present embodiment differs from the recording apparatus 1 of the embodiment 1 in that the configuration allows for the sticking section to automatically vary the pressure force applied to the recording medium without the need for the control of the control unit, during the stopping and movement associated with the intermittent conveyance of the recording medium P. As represented in FIG. 5, a pressure section 36 of the present embodiment urges the pressure roller 12 in a direction D, using a spring or the like (not shown). The pressure section 36 is provided obliquely with respect to the adhesive belt 10; when the recording medium P is being conveyed in the direction of conveyance A, the direction D corresponds to the direction in which the pressure roller 12 advances obliquely from above as seen from the recording medium P (a direction having a vector in the opposite direction with respect to the direction of conveyance A). The urging of the pressure roller 12 in the direction D, which has a vector in the opposite direction with respect to the direction of conveyance A of the recording medium P, causes a force in the opposite direction with respect to the direction of conveyance A to be applied to the recording medium P while the recording medium P is being conveyed in the direction of conveyance A, and the pressure force applied by the pressure roller 12 to the recording medium P is greater during movement than during stopping of the recording medium P associated with the intermittent conveyance.

In another expression of the foregoing, the recording apparatus 1 of the present embodiment is provided with the pressure section 36 as an adjustment section for adjusting the pressure force of the pressure roller 12, as the sticking section, on the recording medium P. The pressure section 36 varies the pressure force so that the pressure force applied by the pressure roller 12 during conveyance of the recording medium P is greater than the pressure force during stopping of the recording medium P. Like the recording apparatus 1 of the embodiment 1, the configuration of such description gives the recording apparatus 1 of the present embodiment a configuration that allows for the suppression of an uneven thickness of the recording medium P and enables suppression of an uneven coloring of the recorded image.

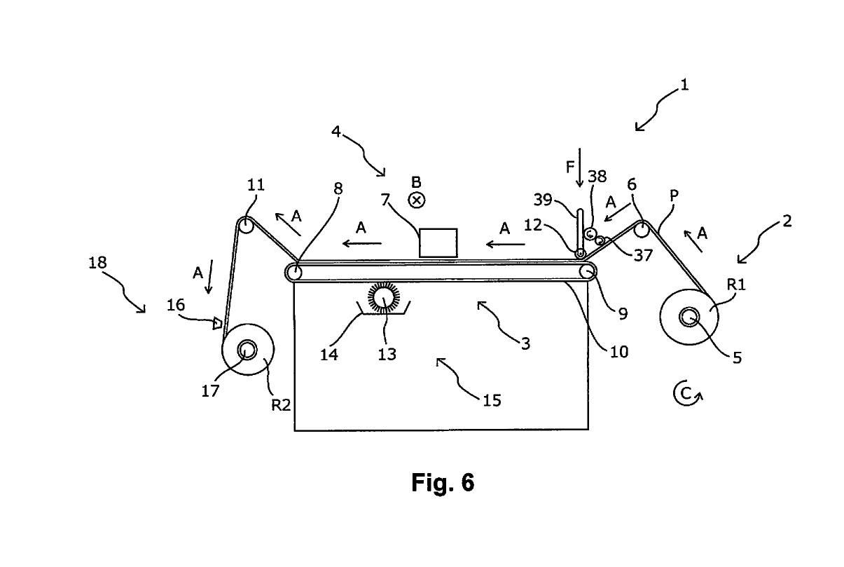

### Embodiment 3 (FIG. 6)

A recording apparatus as in an embodiment 3 of the present invention shall be described next. FIG. 6 is a schematic side view representing the recording apparatus as in the embodiment 3 of the present invention. Constituent members that are in common with the embodiments described above have been assigned like reference numerals, and a detailed description thereof is omitted herein.

The recording apparatus 1 of the present embodiment differs from the recording apparatus 1 of the embodiment 1 in that the configuration allows for the sticking section to vary the pressure force applied by the sticking section to the recording medium, with an adjustment mechanism using a tandem roller that rotates in tandem with the recording medium being conveyed, instead of the adjustment of the pressure force by the control of the control unit, during the stopping and movement associated with the intermittent conveyance of the recording medium P. As represented in FIG. 6, a sticking section 12 of the present embodiment is urged in a direction F by a spring or the like (not shown) via a bearing section 39. Also included are a tandem roller 37 that is in contact with the recording medium P and rotates in tandem with the conveyance of the recording medium P, and a friction roller 38 that is in tandem with the tandem roller 37. The friction roller 38 is also in contact with the bearing section 39.

The configuration of such description makes it possible to cause a greater pressure force to be applied to the recording medium P during movement than during stopping of the recording medium P associated with the intermittent conveyance, because the friction roller 38, by rotating in the direction of the arrow in the drawing, creates a frictional force (pressure force) in the direction F at the site of contact with the bearing section 39 during the conveyance of the recording medium P.

In another expression of the foregoing, the recording apparatus 1 of the present embodiment is provided with the tandem roller 37 rotating in tandem with the recording medium P, the friction roller 38, and the bearing section 39, as an adjustment section for adjusting the pressure force applied by the pressure roller 12, as the sticking section, to the recording medium P. The tandem roller 37, the friction roller 38, and the bearing section 39 vary the pressure force so that the pressure force applied by the pressure roller 12 during conveyance of the recording medium P is greater than the pressure force during stopping of the recording medium P. Like the recording apparatus 1 of the embodiment 1, the configuration of such description gives the recording apparatus 1 of the present embodiment a configuration that allows for the suppression of an uneven thickness of the recording medium P and enables suppression of an uneven coloring of the recorded image.

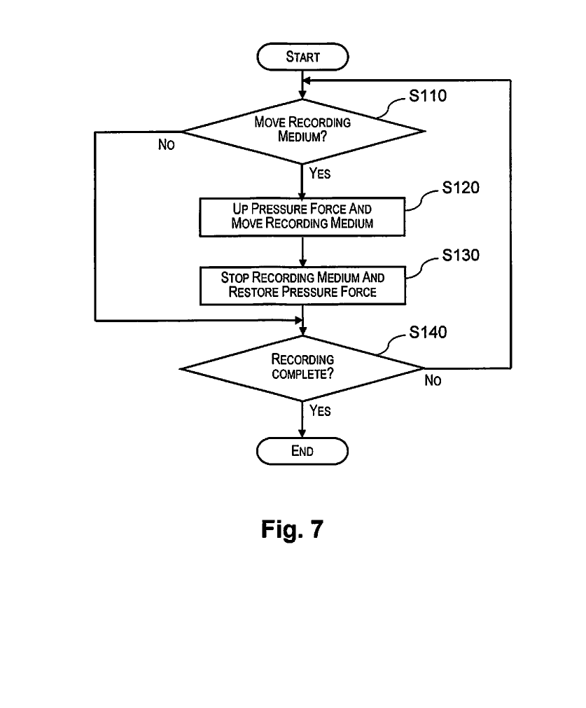

### Embodiment of Recording Method (FIG. 7)

A recording method as in an embodiment of the present invention shall be described next. FIG. 7 is a flow chart representing a recording method as in an embodiment of the present invention. The recording method of the present embodiment is an embodiment that is carried out using the recording apparatus 1 of the embodiment 1.

When recording data is inputted to the recording apparatus 1 as a recording start command, then first, in step S110, the control unit 20 determines whether or not to move the recording medium in association with the intermittent conveyance. In a case where recording is carried out and thus the recording medium is moved in association with the intermittent conveyance, the flow advances to step S120. The flow advances to step S140, however, in a case where recording is not carried out and thus the recording medium is not moved in association with the intermittent conveyance.

In step S120, by controlling the pressure roller drive section 19, the control unit 20 ups the pressure force applied by the pressure roller 20 to the recording medium P, and also the control unit 20 moves the recording medium P by controlling the conveyance mechanism 3. The movement distance of the recording medium P in this step is the movement distance of the recording medium P per instance of conveyance corresponding to the reciprocal scanning of the recording head 7. When the recording medium P is moved by a predetermined conveyance distance, then in step S130, the control unit 20 controls the conveyance mechanism 3 and thereby stops the recording medium P, and also the control unit 20 controls the pressure roller drive section 19 and thereby restores the pressure force applied by the pressure roller 20 to the recording medium P. The pressure force that is restored in this step is the pressure force of before the pressure force was upped in step S120. The flow next proceeds to step S140.

In step S140, the control unit 20 determines whether or not the recording of the recording data inputted to the recording apparatus 1 has been completed. In a case where it is determined in this step that the recording has not been completed, then steps S110 to S140 are repeated until it is determined that the recording is completed, and in a case where it is determined that the recording has been completed, then the recording method as in the present embodiment is completed.

What is claimed is:

1. A recording apparatus comprising:
a conveyance mechanism having an adhesive belt on which a recording medium is placed, and configured and arranged to intermittently convey the recording medium;
a sticking section configured and arranged to apply pressure to the recording medium to stick the recording medium to the adhesive belt; and
an adjustment section configured and arranged to adjust a pressure force applied by the sticking section to the recording medium, the adjustment section being configured and arranged to change the pressure force so that the pressure force during conveyance of the recording medium is greater than the pressure force during stopping of the recording medium.

2. The recording apparatus as set forth in claim 1, wherein
the adjustment section includes a rotating section configured and arranged to rotate in tandem with the recording medium being conveyed.

3. The recording apparatus as set forth in claim 1, wherein
the adjustment section is configured and arranged to control the pressure force of the sticking section so as to reduce a difference between: a product of the pressure force and pressure time applied per unit surface area during the stopping of the recording medium associated with the intermittent conveyance; and a product of the pressure force and pressure time applied per unit surface area during the conveyance of the recording medium associated with the intermittent conveyance.

4. The recording apparatus as set forth in claim 1, wherein
a portion of the sticking section configured and arranged to contact the recording medium has a length in a direction of scanning that is equal to or greater than a length of the recording medium in the direction of scanning.

5. The recording apparatus as set forth in claim 1, further comprising
a movement mechanism for the sticking section configured and arranged to move the sticking section so as to draw closer to or farther away from the adhesive belt.

6. A recording method performed by using a recording apparatus including: a conveyance mechanism having an adhesive belt on which a recording medium is placed, and configured and arranged to intermittently convey the recording medium; and a sticking section configured and arranged to apply pressure to the recording medium to stick the recording medium to the adhesive belt, the recording method comprising:
adjusting a pressure force applied by the sticking section to the recording medium so that the pressure force applied during conveyance of the recording medium is greater than the pressure force applied during stopping of the recording medium.
